(19) United States
(12) Patent Application Publication
(10) Pub. No.: US 2015/0297998 A1
(43) Pub. Date: Oct. 22, 2015

(54) HYPERLINK INITIATION OF GAME SESSIONS

(71) Applicant: Microsoft Corporation, Redmond, WA (US)

(72) Inventors: Krassimir Emilov Karamfilov, Sammamish, WA (US); John Raymond Justice, Bellevue, WA (US)

(73) Assignee: Microsoft Corporation, Redmond, WA (US)

(21) Appl. No.: 14/254,680

(22) Filed: Apr. 16, 2014

(51) Int. Cl. A63F 13/35

(52) U.S. Cl. CPC A63F 13/35

(57) ABSTRACT

A hyperlinked resource identifier that is selectable to allow a player to engage in a game session having a particular game state. The resource identifier has appropriate game session information embedded therein, such that when the resource identifier is selected, a game participation request, and the associated session information, is dispatched to an assignment server associated with the resource identifier. The assignment server assigns a game server to fulfill the request. For instance, the game server might be a game server that is already executing the game if the session information identifies an already existing game, or may be any appropriate game server if the game has not yet begun. The session information might identify any information suitable for defining the gaming experience of the session.

### BACKGROUND

Computing systems have revolutionized the way people communicate, do business, and play. For instance, a user may engage in complex, sophisticated and realistic games using the considerable computing power of conventional gaming consoles. In order to engage in conventional rich gaming experience, a player might typically purchase a gaming console, and also purchase a game. This alone represents a considerable investment for the player. However, there are also a wide variety of games available for any given game console. Furthermore, online services are also available to enable or enhance the gaming experience by, for example, enabling players to engage in a distributed game in which players are remotely located. Nevertheless, the player is often limited to engaging in the game when in the proximity of the gaming console.

Gamers can also engage in online games in which much of the processing power is remotely located. For instance, a user might interact with a social media application to begin a game. The game state associated with the game may be kept on a remote location and/or local to the gamer. So long as game state is preserved, the gamer may continue the game from that preserved state.

The subject matter claimed herein is not limited to embodiments that solve any disadvantages or that operate only in environments such as those described above. Rather, this background is only provided to illustrate one exemplary technology area where some embodiments described herein may be practiced.

### BRIEF SUMMARY

At least some embodiments described herein provide a player with the ability to engage in a game session having a particular game state by simply selecting a hyperlinked resource identifier (for instance, a uniform resource identifier, such as a uniform resource locator). The resource identifier has appropriate game session information embedded therein, such that when the resource identifier is selected, a game participation request, and the associated session information, is dispatched to an assignment server associated with the resource identifier. The assignment server assigns a game server to fulfill the request. For instance, the game server might be a game server that is already executing the game if the session information identifies an already existing game, or may be any appropriate game server if the game has not yet begun.

The session information might identify any information suitable for defining the gaming experience of the session. For instance, the session information might identify that the game session is a trial session in which there are one or more restrictions imposed. Thus, by sharing a resource identifier, the user might select the resource identifier, and be thereby permitted to engage in a trial session. Thus, friends might share such resource identifiers, and if the friends like the game, they might purchase the full version.

This summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

In order to describe the manner in which the above-recited and other advantages and features of the invention can be obtained, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1 illustrates an example computing system in which the principles described herein may be employed;

FIG. 2 illustrates a flow in which principles described herein may operate in which a user interacts with a resource identifier to engage in a game session;

FIG. 3 illustrates a flowchart of a method for participating in a game having a session defined by a resource; and

FIG. 4 illustrates a flowchart of a method for generating a uniform resource identifier that is selectable to engage in a game having a game session.

### DETAILED DESCRIPTION

At least some embodiments described herein provide a player with the ability to engage in a game session having a particular game state by simply selecting a hyperlinked resource identifier (for instance, a uniform resource identifier, such as a uniform resource locator). The resource identifier has appropriate game session information embedded therein, such that when the resource identifier is selected, a game participation request, and the associated session information, is dispatched to an assignment server associated with the resource identifier. The assignment server assigns a game server to fulfill the request. For instance, the game server might be a game server that is already executing the game if the session information identifies an already existing game, or may be any appropriate game server if the game has not yet begun.

The session information might identify any information suitable for defining the gaming experience of the session. For instance, the session information might identify that the game session is a trial session in which there are one or more restrictions imposed. Thus, by sharing a resource identifier, the user might select the resource identifier, and be thereby permitted to engage in a trial session. Thus, friends might share such resource identifiers, and if the friends like the game, they might purchase the full version.

Although the subject matter has been described in language specific to structural features and/or methodological acts, it is to be understood that the subject matter defined in the appended claims is not necessarily limited to the described features or acts described above, or the order of the acts described above. Rather, the described features and acts are disclosed as example forms of implementing the claims.

Computing systems are now increasingly taking a wide variety of forms. Computing systems may, for example, be handheld devices, appliances, laptop computers, desktop computers, mainframes, distributed computing systems, or even devices that have not conventionally been considered a computing system. In this description and in the claims, the term “computing system” is defined broadly as including any device or system (or combination thereof) that includes at least one physical and tangible processor, and a physical and tangible memory capable of having thereon computer-executable instructions that may be executed by the processor. A computing system may be distributed over a network environment and may include multiple constituent computing systems.

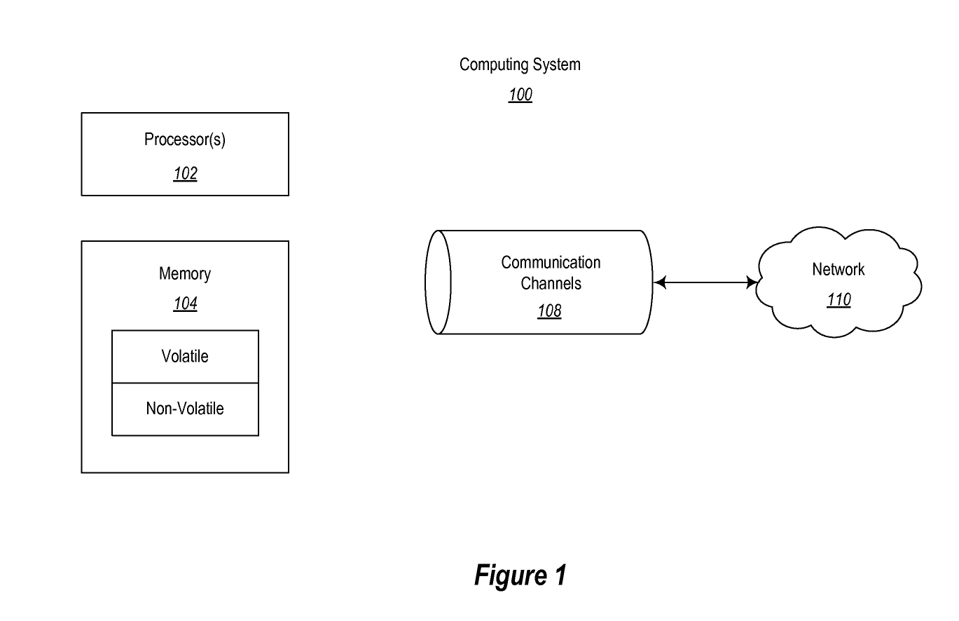

As illustrated in FIG. 1, in its most basic configuration, a computing system 100 typically includes at least one processing unit 102 and memory 104. The memory 104 may be physical system memory, which may be volatile, non-volatile, or some combination of the two. The term “memory” may also be used herein to refer to non-volatile mass storage such as physical storage media. If the computing system is distributed, the processing, memory and/or storage capability may be distributed as well.

As used herein, the term “executable module” or “executable component” can refer to software objects, routings, or methods that may be executed on the computing system. The different components, modules, engines, and services described herein may be implemented as objects or processes that execute on the computing system (e.g., as separate threads).

In the description that follows, embodiments are described with reference to acts that are performed by one or more computing systems. If such acts are implemented in software, one or more processors of the associated computing system that performs the act direct the operation of the computing system in response to having executed computer-executable instructions. For example, such computer-executable instructions may be embodied on one or more computer-readable media that form a computer program product. An example of such an operation involves the manipulation of data. The computer-executable instructions (and the manipulated data) may be stored in the memory 104 of the computing system 100. Computing system 100 may also contain communication channels 108 that allow the computing system 100 to communicate with other message processors over, for example, network 110.

Embodiments described herein may comprise or utilize a special-purpose or general-purpose computer system that includes computer hardware, such as, for example, one or more processors and system memory, as discussed in greater detail below. The system memory may be included within the overall memory 104. The system memory may also be referred to as “main memory”, and includes memory locations that are addressable by the at least one processing unit 102 over a memory bus in which case the address location is asserted on the memory bus itself. System memory has been traditional volatile, but the principles described herein also apply in circumstances in which the system memory is partially, or even fully, non-volatile.

Embodiments within the scope of the present invention also include physical and other computer-readable media for carrying or storing computer-executable instructions and/or data structures. Such computer-readable media can be any available media that can be accessed by a general-purpose or special-purpose computer system. Computer-readable media that store computer-executable instructions and/or data structures are computer storage media. Computer-readable media that carry computer-executable instructions and/or data structures are transmission media. Thus, by way of example, and not limitation, embodiments of the invention can comprise at least two distinctly different kinds of computer-readable media: computer storage media and transmission media.

Computer storage media are physical hardware storage media that store computer-executable instructions and/or data structures. Physical hardware storage media include computer hardware, such as RAM, ROM, EEPROM, solid state drives (“SSDs”), flash memory, phase-change memory (“PCM”), optical disk storage, magnetic disk storage or other magnetic storage devices, or any other hardware storage device(s) which can be used to store program code in the form of computer-executable instructions or data structures, which can be accessed and executed by a general-purpose or special-purpose computer system to implement the disclosed functionality of the invention.

Transmission media can include a network and/or data links which can be used to carry program code in the form of computer-executable instructions or data structures, and which can be accessed by a general-purpose or special-purpose computer system. A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer system, the computer system may view the connection as transmission media. Combinations of the above should also be included within the scope of computer-readable media.

Further, upon reaching various computer system components, program code in the form of computer-executable instructions or data structures can be transferred automatically from transmission media to computer storage media (or vice versa). For example, computer-executable instructions or data structures received over a network or data link can be buffered in RAM within a network interface module (e.g., a “NIC”), and then eventually transferred to computer system RAM and/or to less volatile computer storage media at a computer system. Thus, it should be understood that computer storage media can be included in computer system components that also (or even primarily) utilize transmission media.

Computer-executable instructions comprise, for example, instructions and data which, when executed at one or more processors, cause a general-purpose computer system, special-purpose computer system, or special-purpose processing device to perform a certain function or group of functions. Computer-executable instructions may be, for example, binaries, intermediate format instructions such as assembly language, or even source code.

Those skilled in the art will appreciate that the principles described herein may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like. The invention may also be practiced in distributed system environments where local and remote computer systems, which are linked (either by hardwired data links, wireless data links, or by a combination of hardwired and wireless data links) through a network, both perform tasks. As such, in a distributed system environment, a computer system may include a plurality of constituent computer systems. In a distributed system environment, program modules may be located in both local and remote memory storage devices.

Those skilled in the art will also appreciate that the invention may be practiced in a cloud computing environment. Cloud computing environments may be distributed, although this is not required. When distributed, cloud computing environments may be distributed internationally within an organization and/or have components possessed across multiple organizations. In this description and the following claims, “cloud computing” is defined as a model for enabling on-demand network access to a shared pool of configurable computing resources (e.g., networks, servers, storage, applications, and services). The definition of “cloud computing” is not limited to any of the other numerous advantages that can be obtained from such a model when properly deployed.

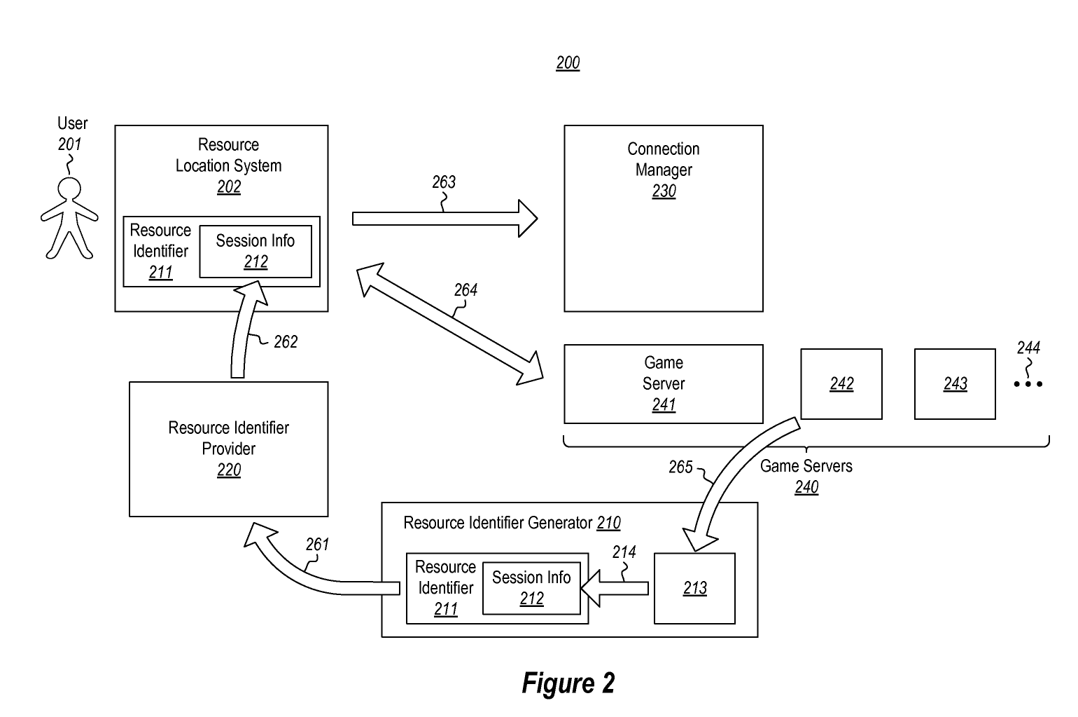

FIG. 2 illustrates a flow 200 in which principles described herein may operate. A user 201 (e.g., a game player) interacts with a resource location system 202, which permits the user to navigate to web sites (or other resources) that are represented by a resource identifier. As an example herein, a Uniform Resource Identifier (or URI) is provided as an example of a resource identifier. Accordingly, when the term URI is used hereinbelow, the same principles described herein as applying to the URI will also apply to any resource identifier, even one that does not have global uniformity. A further example of a URI is a Uniform Resource Locators (URLs) (such as a world wide web address or an Internet Protocol (IP) address). In the case of the resource identifier being a URI or URL, the resource location system 202 might be a browser.

To access the resource, a user might select a hyperlink associated with the resource identifier, (or otherwise input the resource identifier into an appropriate field), causing the resource location system to emit a web request, which is conventionally often in the form of a HyperText Transport Protocol (HTTP) request. The web request results in the resource locator system 202 navigating to the resource (such as a web site). The resource location system 202 may be any computing system, an example of which being the computing system 100 of FIG. 1, and may be a conventional computing system, or a computing system yet to be developed. The browser system 202 runs thereon an application that facilitates the resource navigation.

The principles described herein are facilitated by a resource identifier (an example being a URI or URL) that contains session information associated with a game. The session information is structured within the resource identifier such that the web request includes at least some, and perhaps all, of that game session information. For instance, the resource location system 202 is illustrated as displaying a resource identifier 211, which has therein associated session information 212.

Resource identifiers (and URIs and URLs in particular) may typically be freely passed from one network node to another. For instance, a resource identifier generator 210 is illustrated as generating the resource identifier 211 having session information 212 contained therein. As represented by arrows 261 and 262, the resource identifier 211 is provided to the resource location system 202 perhaps through a resource identifier provider system 220. The resource identifier generator 210 may be any computing system, an example of which being the computing system 100 of FIG. 1, and may be a conventional computing system, or a computing system yet to be developed. Likewise, the resource identifier provider 220 may be any computing system, an example of which being the computing system 100 of FIG. 1, and may be a conventional computing system, or a computing system yet to be developed.

When the resource identifier is formulated, a session information generation module 213 generates (as represented by arrow 214) the session information 212. The session information 212 may be based on associated with a game that is already in progress, or that has been played to a certain point. In that case, the session information generation module 213 may generate at least part of the session information using the current game state of the game already in progress, or the game state of the game played to the certain point.

The session information 212 may alternatively be associated with a game that has not yet begun. For instance, the game session to be initiated may be a trial session for a game, in which case one or more restrictions may be applied to the trial session. The session information may expressly or implicitly identify the one or more restrictions that are to be applied to the trial session. For instance, the trial session may limit achievements that may be earned during the trial session, the amount of time of the trial session, one or more avatar or weapon abilities available the trial session, the scenarios that may be played during the trial session, and/or which game resources may be used during the trial session.

In accordance with the principles described herein, the selection of the resource identifier 211 allows the user to connect to a game server to play a game that is defined by the session information 212 contained within the resource identifier 211. Accordingly, the ability of resource identifiers to be shared may be leveraged in session for a game by simply sharing resource identifiers via any available accordance with the principles described herein in order to permit the sharing a specific game experience. Thus, game providers may allow users to engage in a trial mechanism, such as social media, e-mail, web sites. Friends may forward resource identifiers to other friends for a variety of purposes such as 1) encouraging a friend to engage in a trial game session represented by the resource identifier, 2) asking a friends help in accomplishing a particular game scenario represented by the resource identifier, and 3) inviting a friend to participate in a current game represented by the resource identifier. Furthermore, a player may save session information associated with a game that the actual player has participated in by having the session information saved in the resource identifier.

The resource identifier generation module 210 is thus not limited to a particular manner of generating the session information 212, nor is there necessarily a single instance of the resource identifier generation module 210. The context in which a resource identifier is generated depends on what type of session information is being included. For instance, if the resource identifier represents a trial session of the game, the resource identifier may be generated by the game provider or marketer. If the resource identifier represents a prior state of a game engaged in by a player, the game system (e.g., a game system running local to the previous player and/or a game server that was executing the game) may generate the resource identifier representing the game state available to it at the point generation of the session information.

The resource identifier 211 may then be passed openly and freely via any conventional mechanism (as represented by arrows 261 and 262), or via any means for sharing resource identifiers that may become available in the future. Ultimately, however, the player 201 comes to access the resource identifier via their resource location system 202. In particular, the resource identifier is provided by a resource identifier provider system 220 (as represented by arrow 262). As an example, if the resource identifier was provided in an e-mail, the resource identifier provider system 220 would be an e-mail system. If the resource identifier was provided as a hyperlink in a web page, the resource identifier provider system 220 would be that web page. If the hyperlink were included within a social media posting, the social media application would be the resource identifier provider system 220. The resource identifier provider system 220 may also be a billboard that the player happens to see upon driving one day, which the user copies down or remembers for purposes of evaluating the game later on. The identity and nature of the resource identifier provider system 220 will thus depend on how the player came across the resource identifier.

The resource identifier 211 is structured to be interpretable by the resource location system 202 as hyperlinking to a connection manager 230. When the resource identifier 211 is selected, at least some of the session information 212 is included within a web request that is then dispatched (as represented by arrow 263) to the connection manager 230. The connection manager 230 interprets the session information within the resource identifier and combines that information with other information it might have on the player (e.g. new player, existing player, entitlements, and so forth) and make decisions based on the combined information. The connection manager 230 further negotiates a connection (as represented by arrow 264) between the resource location system 202 and a suitable game server 241 that is capable of providing the gaming experience to the user 201. Accordingly, regardless of how the player 201 came upon the resource identifier 211, the player 201 may then engage in the game having a session defined by the resource identifier 211. Each of the connection manager 230 and the game server 241 may be structured as described for the computing system 100 of FIG. 1.

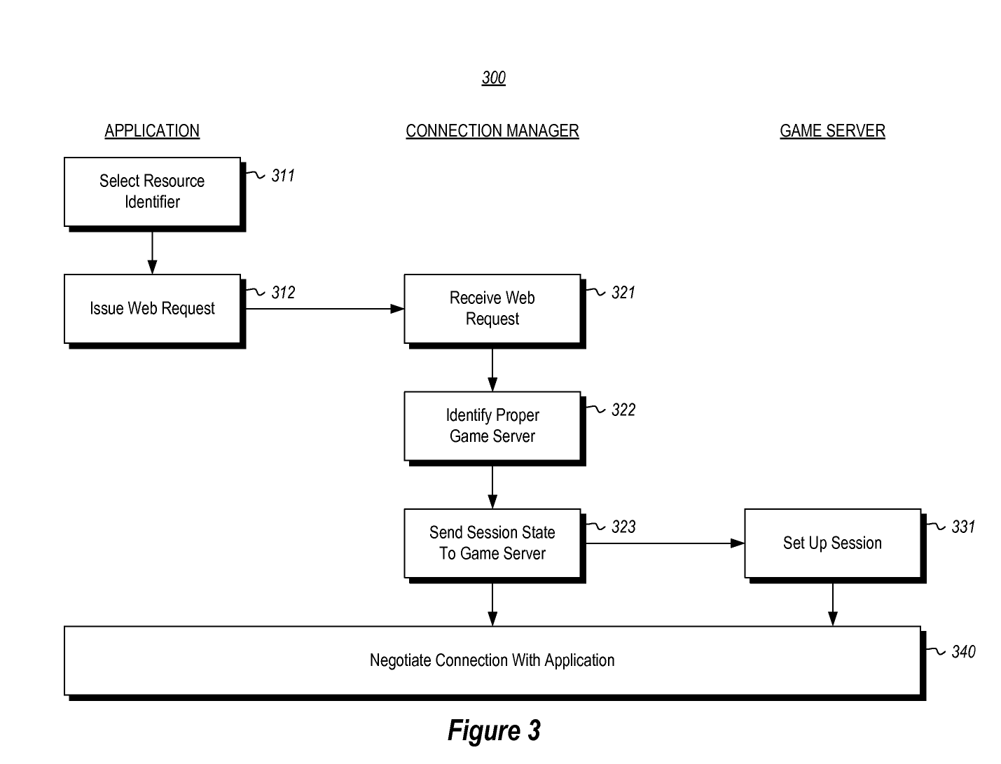

FIG. 3 illustrates a flowchart of a method 300 for participating in a game having a session defined by a resource identifier. Some of the acts are performed by a resource location system (e.g. resource location system 202) associated with a player (e.g., player 201), as represented in the left column of FIG. 3 under the heading “APPLICATION”. Some of the acts are performed by a connection manager (e.g. connection manager 230), as represented in the middle column of FIG. 3 under the heading “CONNECTION MANAGER. Others of the acts are performed by an assigned game server system (e.g., one of the game servers 240), as represented in the right column of FIG. 3 under the heading “GAME SERVER”.

The method 300 is initiated by the resource locator system selecting the resource identifier that includes the session information (act 311). For instance, the resource locator system 202 selects the resource identifier 211 having the session information. The resource locator system 202 may perform this selection in response to user interaction with an application running on the resource locator system 202. In response, the resource locator system 202 issues a web request to the connection manager (act 312). For instance, in FIG. 2, a user 201 uses the resource locator system 202 to issue a web request (as represented by arrow 263) to the connection manager server 230. The web request includes at least some of the session information included within the resource identifier.

The connection manager then receives the web request (act 321), which the connection manager interprets as a game participation request in the sense that the connection manager responds to the web request by facilitating a connection between a game server and the resource location system. Thus, the player may thereafter engage in a game specifically defined by the session information included within the web request. The web request is “identifier-sourced” in that the web request is generated in response to a selection of the resource identifier.

The connection manager then uses the session information to identify a game server computing system (act 322) that is executing, or that is to execute, the game associated with the game session. For instance, in FIG. 2, the connection manager 230 may have a number of game servers 240 to choose from. In this case, the game servers 240 are illustrated as including three game servers 241, 242 and 243. However, the ellipses 244 illustrate that the game servers 240 may include any number of game servers.

The connection manager 230 passes part of the session information to the identified game server (act 323). The game server then uses the session information to set up the session (act 331), and the game server then establishes a session with the resource identifier system (act 340).

For instance, the game server 241 might impose any restrictions or limitations if the game is a trial experience. Thus, the principles described herein enable trial game sessions or other restricted game sessions. The game session might also be restricted based on likely user preferences based on where the resource identifier was found. For instance, if the resource identifier was found by a user on a web page especially suited to a particular audience (based on gender, age, interests, and so forth), the corresponding game session may include some customization to make the game more appealable to that audience.

The game server 241 might use the identified session information to allow the player to participate in a game session that is already in progress, with one or more players already participating. This represents a kind of live joining of players into an active game session.

The game server 241 might use the session information to reconstruct game state for a game in which one or more players had already engaged in the game to that point, but in which none of the players are still playing. This represents a kind of unpausing or resuming of a previous game. The player beginning at that point may be the same as a previous player that participated in the game (such as in the unpause or resume scenario), or it may be a different player in cases in which collaboration is used in order to advance through game state.

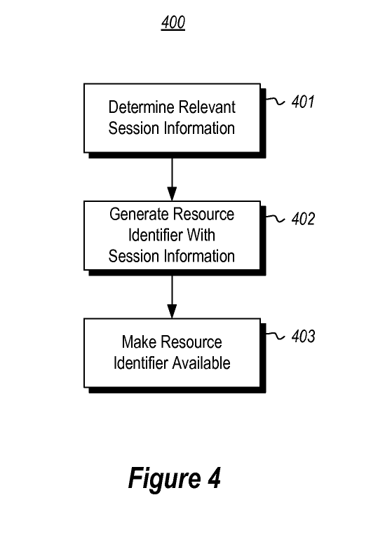

Referring to FIG. 2, recall that the resource identifier generator 210 generates the resource identifier 211. FIG. 4 illustrates a flowchart of a method 400 for generating a resource identifier that is selectable to engage in a game having a game session. The method 400 may be performed by the resource identifier generator 210 in order to generate the resource identifier 211. In particular, if the game session corresponds to a game that had already been partly played on the game server 242, the game server 242 might provide the game session information to the session information generation module 213 as represented by arrow 265. Alternatively or in addition, the game session information might be defined by a promoter of the game (such as might be the case for a trial session). In any case, the resource identifier generator determines the relevant game information (act 401). The resource identifier generator then generates a resource identifier that is interpretable by a computing system as hyperlinking to a connection manager (act 402). For instance, the resource identifier generator 210 generates the resource identifier 211. The resource identifier is then made available externally (act 403). For instance, the resource identifier 211 might be provided to a web site, in an e-mail, in social media, or any other location that may be accessed by the resource location system 202.

Accordingly, the principles described herein allow any resource location system to select a resource identifier, and thereby launch the resource location system into a gaming experience that is configured with session information. Such enables trial game sessions, shared game sessions, customized game sessions suitable for a target audience, and so forth. Furthermore, this is enabled without requiring a game console as any suitable computing system with a resource location system may render game state.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

1. A method for assisting to connect to a game associated with a session, the method comprising:
an act of receiving a hyperlink-sourced game participation request from a client computing system, the game participation requesting comprising session information associated with a game; and
an act of using the session information to identify a game server computing system that is executing, or that is to execute, the game having the session information; and
an act of passing at least part of the session information to the identified game server computing system.

2. The method in accordance with claim 1, the game being a game already in progress, the identified game server computing system already executing the game already in progress.

3. The method in accordance with claim 2, wherein one or more players are already engaged with the game at the time the hyperlink-sourced game participation request is received.

4. The method in accordance with claim 3, at least one of the one or more players still engaging with the game at the time the hyperlink-sourced game participation request is received.

5. The method in accordance with claim 3, none of the one or more players still being engaged with the game at the time the hyperlink-sourced game participation request is received.

6. The method in accordance with claim 3, a player that selected a hyperlink that automatically caused the hyperlink-sourced game participation request being a same player as one of the one or more players that have already been engaged with the game.

7. The method in accordance with claim 1, the game being a game not yet initiated at the time the game server computing system is identified.

8. The method in accordance with claim 7, the session information corresponding to a trial session.

9. The method in accordance with claim 8, the session information corresponding to at least one restriction to be applied in the trial session.

10. The method in accordance with claim 8, the restriction restricting achievements that may be earned during the trial session.

11. The method in accordance with claim 8, the restriction restricting a score that may be earned during the trial session.

12. The method in accordance with claim 8, the restriction restricting an amount of time of the trial session.

13. The method in accordance with claim 8, the restriction restricting one or more abilities of an avatar of the trial session.

14. The method in accordance with claim 8, the restriction restricting one or more scenarios that may be played during the trial session.

15. The method in accordance with claim 8, the restriction restricting one or more game resources that may be used during the trial session.

16. A computer program product comprising one or more computer-readable storage media having thereon computer-executable instructions that are structured, such that, when executed by one or more processors of a computing system are configured to perform a method for generating a uniform resource identifier that is selectable to engage in a game having a game session, the method comprising:
an act of determining game session information; and
an act of generating a uniform resource identifier that is interpretable by a computing system as hyperlinking to a connection manager, the uniform resource identifier further comprising at least part of the game session information.

17. The computer program product in accordance with claim 16, the game session information associated with a game that has not yet begun.

18. The computer program product in accordance with claim 16, the game session information associated with a game already in progress.

19. The computer program product in accordance with claim 16, the method further comprising:
an act of providing the resource identifier within a social media user interface.

20. A method for connecting a player to a game associated with a session, the method comprising:
an act of accessing a game participation request from a client computing system, the game participation request having associated session information for a game, the game participation request structured as a request automatically generated upon selection of a hyperlink having an associated resource identifier, the associated session information represented in the resource identifier and also automatically included within the game participation request upon selection of the hyperlink;
an act of using the session information to identify a game server computing system that is executing, or that is to execute, the game having the session information; and
an act of passing at least part of the session information to the identified game server computing system with an instruction to establish a game session using the session information and connector the request to the corresponding game.

21. A computer-implemented method for providing a resource identifier that may be universally shared without being tied to a particular gaming platform so that when selected, the resource identifier permits a user to engage in a trial session of a particular digital video game without having to first invest in specialized gaming hardware, purchase of the particular video game or enrollment in a particular online gaming service, the computer-implemented method comprising executing on one or more processors of one or more computing systems the following:
generating session information for a particular digital video game;
generating a resource identifier which contains the generated session information;
sharing the generated resource identifier which contains the generated session information with a prospective player using any of various available mechanisms, including social media, e-mail and one or more web sites, so that a prospective player with whom the generated resource identifier is shared may engage in a trial session of a particular digital video game without having to first invest in specialized gaming hardware, purchase of the particular video game or enrollment in a particular online gaming service;
at a resource location system of the prospective player, receiving through any of said available mechanisms a game participation request which includes a hyperlink to the generated resource identifier containing the generated session information; and
after selecting the hyperlink, the resource location system of the prospective player being directed to a connection to a game server computing system that executes the particular digital video game in accordance with the session information contained in the generated resource identifier.
